(19) United States
(12) Patent Application Publication
(10) Pub. No.: US 2007/0154766 A1
(43) Pub. Date: Jul. 5, 2007

(54) Collapsible metal air battery

(76) Inventors: Dong-Soo Baik, Kyunggi-do (KR); Jeong-Yoon Lee, Kyunggi-do (KR)

Correspondence Address: COLEMAN SUDOL SAPONE, P.C., 714 COLORADO AVENUE, BRIDGE PORT, CT, 06605-1601, US

(21) Appl. No.: 10/585,241

(22) PCT Filed: Feb. 16, 2004
(86) PCT No.: PCT/KR04/00306

§ 371 Date: Jan. 8, 2007

(51) Int. Cl. H01M 8/02; H01M 12/06

(52) U.S. Cl. 429/34; 429/127; 429/27

(57) ABSTRACT

The present invention relates to a collapsible metal air fuel cell, and in particular to a collapsible metal air battery capable of generating an electric power in such a manner that an active metal of aluminum and magnesium is oxidized using oxygen from the air. The collapsible metal air battery comprises a unit cell including a pair of metal frames, a rubber housing adhered to left, right and lower sides of the metal frames, a separator and air anode adhered to an outer side of the metal frame, and a plate like metal fuel electrode inserted into the interior of the metal frames.

### TECHNICAL FIELD

The present invention relates to a portable metal air fuel cell, and in particular to a collapsible metal air battery capable of generating an electric power in such a manner that an active metal of aluminum and magnesium is oxidized using oxygen in the air.

### BACKGROUND ART

In a metal air fuel cell, or metal air battery, an anode is generally formed of a metal such as aluminum, magnesium, zinc, etc., or an alloy of the above metals. As electrolyte, salt or alkali aqueous solution is used. Generally, the metal air battery has a large volume of electrolyte solution. An electrolyte solution is filled by at least 30% in the entire volume of the cell.

In the case that a conventional metal air battery is small sized, it is generally formed in a button shape. Metallic powder or plates are filled in the interior of the button-shaped metal can, while it is large sized, it is provided in a box shape having a fixed size. In addition, conventional metal air fuel cells or batteries are designed in such a manner that a liquid electrolyte is not leaked. Therefore, since a conventional metal air cell is formed in a hard structure having a fixed size, it is very inconvenient to carry the same. In addition, since the voltage of the unit cell is lower with 0.8˜1.6 volts, in order to produce a proper high voltage, a plurality of unit cells are connected in series. In the case that a plurality of unit cells is connected in series, it is more inconvenient to carry the cells. Furthermore, the inner structure of the metal air battery may be very complicated because water should be uniformly supplied into each unit cell.

In a dried state that water is removed, as a method for decreasing the weight and volume of the metal air fuel cell, in the U.S. Pat. No. 5,439,758, a collapsible type air electrode bag is disclosed. Although the cells are made collapsible, for decreasing the dry volume and weight by evacuating the battery, there are some problems to be overcome for practical use. Firstly, the hydrophobic layer of the air cathode may be easily peeled off. Namely, the hydrophobic layer may be separated from carbon and nickel mesh of the air cathode. In addition, in the case that a chemical adhesive is used, a sealing property may be degraded due to repeated use of the same. In order to overcome the above problems, a mechanical gripper capable of securing a rim of the adhered portion of the collapsible container and an air cathode, and the better bonding technique are needed. Secondly, covering one side of a metal air fuel electrode using an insulation plate may decrease an electrochemical effective area. Therefore, a structure that two air cathodes surround one anode plate is advantageous for achieving the larger power. Thirdly, the above U.S. Pat. No. 5,439,758 is not proper for a repeated use of structure and material. In particular, the material of vinyl may become hardened at a low temperature of −20° C. and may be damaged.

### DISCLOSURE OF INVENTION

Accordingly, it is an object of the present invention to provide a collapsible metal air battery that overcomes the problems encountered in the conventional art.

It is another object of the present invention to provide a collapsible metal air battery that is capable of decreasing the dry weight and volume using an improved structure and material.

It is further another object of the present invention to provide a collapsible metal air battery in which an electric power is instantly generated by external water supply.

Due to the hydrogen evolution, in the case that aluminum and magnesium are used as a metal fuel, a collapsible metal air battery should be designed to have an opened structure, not a sealed structure, for thereby effectively discharging the gas. In addition, there is provided an additional container capable of supplying water, so that an electrolyte is easily made up and filled into the interior of the metal air battery.

To achieve the above objects, there is provided a collapsible metal air battery which includes a unit cell including a pair of metal frames as mechanical grippers holding the air cathodes tightly, a rubber housing adhered to left, right and lower sides of the metal frames, a separator and air cathode adhered to an outer side of the metal frame, and a plate like metal fuel electrode inserted into the interior of the metal frames. To make the unit cell, it is necessary to use a rubber-metal bonding technique utilizing the character of the rubber making very strong bonding to metal surface when the suitable adhesive, curable at high temperature and pressure, is applied between them.

To achieve the above objects, there is provided a method for fabricating a collapsible metal air battery, comprising the steps of a first step for curing at 150˜290° C. for 40˜210 seconds and forming a rubber housing in the metal frames, a second step for adhering a separator to an outer side of the metal frame, a third step for adhering an air cathode to an upper side of the separator, and a fourth step for folding bent portions of the metal frame using a press machine.

In the present invention, the metal frame has bent portions of which four sides of a rectangular metal frame are bent. The inner part of the rectangular metal frame is formed in a window lattice shape such as union jack or is formed with punched holes. Four angular corners of the vent portions of the metal frame are cut away at 45° and are not overlapped from each other when the bent portions of the metal frame are folded. The bent portions are draw-formed with a depth of 0.8˜1.2 mm.

A pair of the rubber tubes is provided in the lower sides of the left and right sides of the rubber housing.

In order to produce a proper high voltage for practical use, a plurality of unit cells of 0.8˜1.6 volts are connected in series. When a plurality of unit cells is connected in series, an air diffusion plate is inserted between the unit cells. A rubber band is adhered to the left and right sides of the cell. In addition, there is further provided a water container having a rubber tube connector. A salt bag formed of a porous non-woven fabric and having an electrolyte salt is provided in the interior of the water container. The air diffusion plate has an air porosity of 90% with 10˜40 ppi(pores per inch) and is formed of rubber sponge. The rubber tube connector is connected with the rubber tube formed in the rubber housing in a zigzag pattern, so that the electrolyte is consecutively supplied.

### BRIEF DESCRIPTION OF DRAWINGS

The present invention will become better understood with reference to the accompanying drawings which are given only by way of illustration and thus are not limitative of the present invention, wherein;

FIG. 1 is a front and cross sectional view of a unit cell according to the present invention;

FIG. 2A is a perspective view illustrating a metal frame formed in a window lattice shape according to the present invention;

FIG. 2B is a perspective view illustrating a metal frame having punched holes according to the present invention;

FIG. 3 is a flow chart of a fabrication process of a unit cell according to the present invention;

FIG. 4 is a view illustrating a second process of FIG. 3;

FIG. 5 is an enlarged cross sectional view of a part of unit cell according to a first embodiment of the present invention;

FIG. 6 is an enlarged cross sectional view of a part of unit cell according to a second embodiment of the present invention;

FIG. 7 is a view illustrating a state that a plurality of unit cells is connected according to the present invention;

FIG. 8A is a view illustrating a state that the unit cells are connected in series are collapsed according to the present invention; and

FIG. 8B is a view illustrating a state that the unit cells are connected in series and are expanded according to the present invention.

### BEST MODE FOR CARRYING OUT THE INVENTION

The collapsible metal air battery according to the present invention will be described with reference to the accompanying drawings.

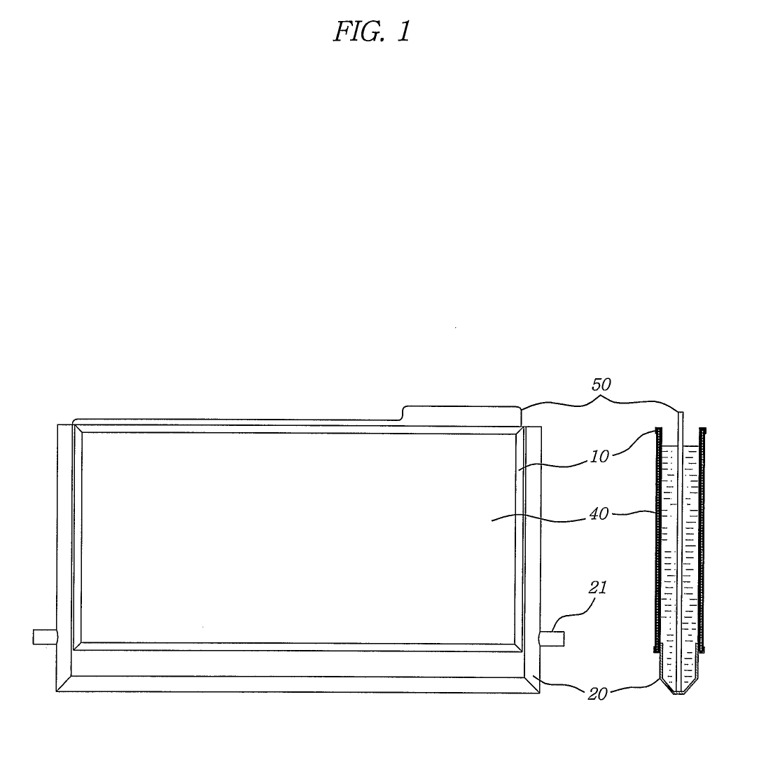

FIG. 1 is a front and cross sectional view of a unit cell according to the present invention. As shown therein, one unit cell includes a pair of metal frames 10, a rubber housing 20 adhered to left, right and lower sides of the metal frames 10, a separator 30 and an air cathode 40 adhered to an outer side of the metal frame 10, and a plate like metal fuel electrode 50 inserted into the interior of the metal frames 10. In order to fabricate the above unit cell, the following steps are performed. Namely, in the first step, the unit cell is cured at 150˜290° C. for 40˜210 seconds for thereby forming a rubber housing 20 bonded to the metal frames 10. In the second step, the separator 30 is adhered to an outer side of the metal frame 10. In the third step, an air cathode 40 is adhered to an upper side of the separator 30. In the fourth step, a bent portion 11 of the metal frame 10 is folded using a press machine. In the above fourth step, more preferably, a metal insertion material 60 is inserted into the interior of the cell, and then the bent portion 11 of the metal frame 10 is compressed.

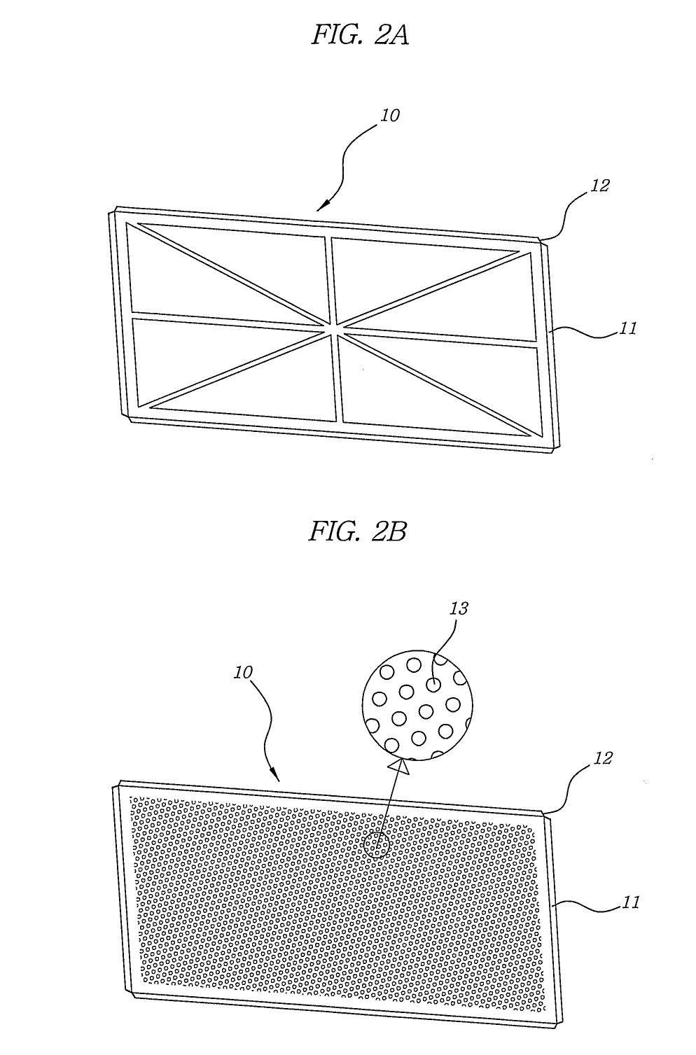

Here, the metal frame 10 is formed of nickel strongly resistant to salt water or a nickel-coated stainless steel plate with a thickness of 0.1˜0.3 mm. The metal frame 10 is adapted to connect the rubber housing 20 and the air cathode 40. The metal frame 10 is rectangular metal frame formed of a window lattice shape such as a union jack or formed with punched holes. The four sides of a rectangular metal frame are bent at 90° for thereby forming bent portions 11. The four bent portions of the metal frame are draw-formed with a depth of 0.8˜1.2 mm, so that it is possible to prevent a rubber resin from leaking into the interior of the metal frame 10 during a rubber molding (FIG. 2A). In addition, the four angular corners of the bent portions 10 are cut away at 45°, so that the bent portions are not overlapped when folding the same.

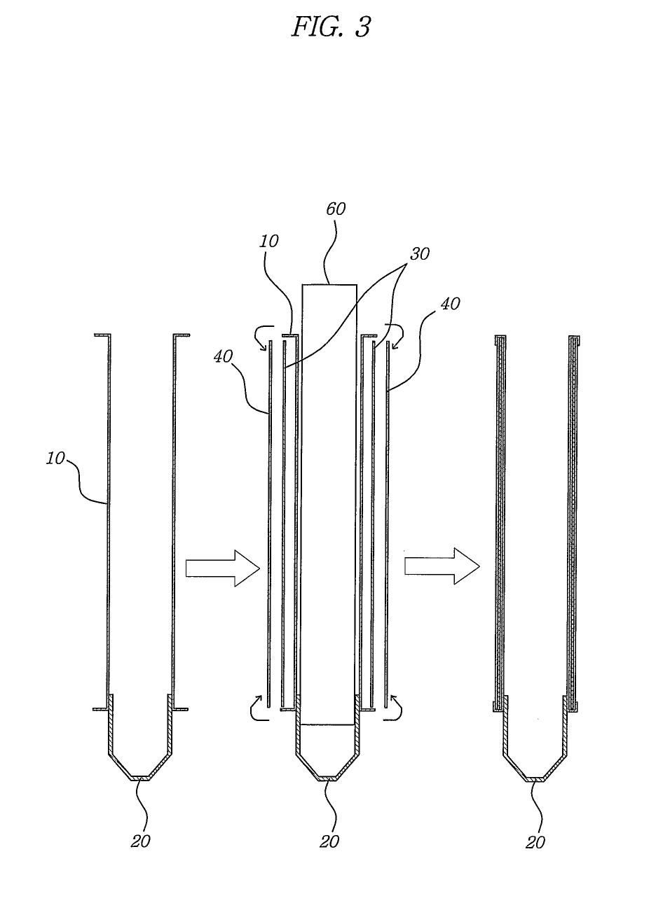

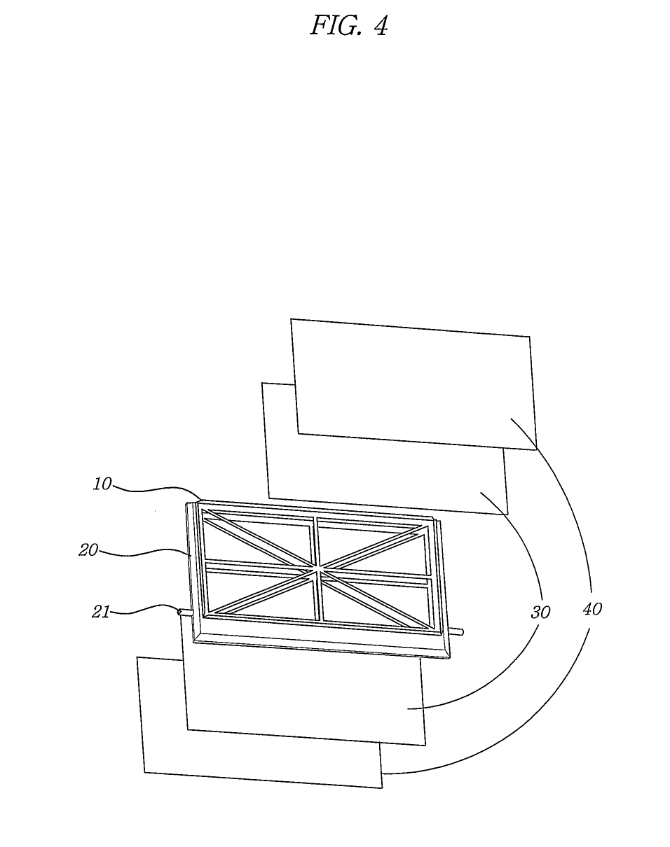

When the rubber housing 20 is formed in the left, right and lower sides of the metal frames 10, an adhesive is applied at the inner side of the mold and then heat and pressure are applied for thereby achieving a good adherence. Before the injection molding or thermal pressure molding, the surfaces of the metal frame 10 is scratched by the sand blast for thereby enhancing an adhering property. At this time, it is cured at 150˜290° C. for 40˜210 seconds more preferably, at 160˜280° C. for 50˜200 seconds, so that the rubber housing 20 is adhered to the metal frame 10 by the rubber-metal bonding technique. A pair of rubber tubes 21 is provided in the lower left and right sides of the rubber housing 20. Thereafter, the separator 30 and the air cathode 40 are sequentially adhered to the outer side of the metal frame 10 (FIGS. 3 and 4).

Here, air cathode 40 is a nickel mesh 43, and one side of the air cathode 40 is coated with a carbon layer 41, and the other side of the same is coated with a hydrophobic layer 42. In a fabrication method of the same, an activated carbon powder is mixed with polytetrafluoroethylene (PTFE) or polyvinylidenefluoride (PVDF, fluorine resin adhesives), and a resultant material is adhered to the nickel mesh 43 by applying heat and pressure. Thereafter, a porous hydrophobic layer is adhered to the surface of the nickel mesh.

When the air cathode 40 is adhered to the separator 30, the separator 30 is adhered to the surface of the air cathode 40 coated with the carbon layer 41. At this time, an adhesive is first applied at edge of the hydrophobic surface of the air cathode for thereby preventing a leakage of water after the assembling is performed. The bent portions 11 of the metal frame 10 are compressed using a press. The metal insertion material 60 is inserted into the interior of the unit cell for achieving a completeness of the folding of the metal frame for thereby compressing using the press. The metal insertion material 60 is removed after the bent portions 11 of the metal frame 10 are folded.

Here, the rubber housing 20 is formed of nitrilebutadine rubber (NBR), ethylene propylene diene monomer rubber (EPDM) or chloroprene rubber (CR). Since the sides of the cell are formed of rubber as mentioned, it is collapsible.

The separator 30 has a thickness of 0.2 mm and is formed of a porous non-woven fabric formed of polypropylene.

In the present invention, the metal fuel electrode 50 is formed in a plate like shape and is formed of an alloy of aluminum and magnesium and has a thickness of 0.5˜4.0 mm. Since the above metal reacts with salt water or weak alkaline solution that is not harmful to human body, it is not needed to store in a sealed container. In addition, an opened structure is more preferably used due to hydrogen gas generated from a corrosion reaction, as compared to a sealed structure.

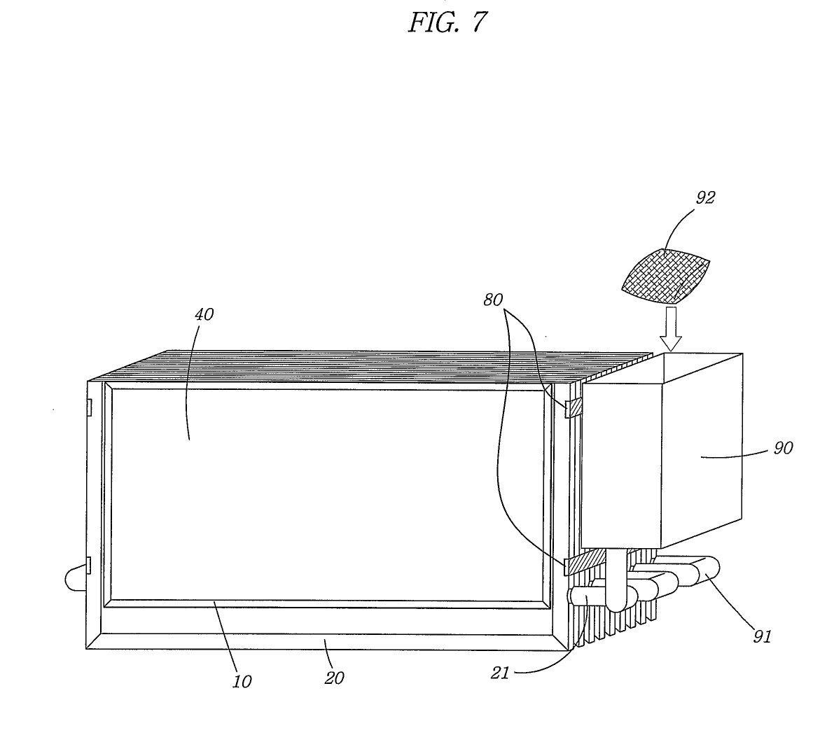

When the unit cells are connected in series, an air diffusion plate 70 is inserted between the unit cells, and a rubber band 80 is adhered to the left and right sides of the cell. Here, a water container 90 having rubber tube connectors 91 is additionally provided. A salt bag 92 formed of a porous non-woven fabric and having an electrolyte salt therein is provided in the interior of the water container 90. Here, the water container 90 is formed of plastic or rubber. The air diffusion plate 70 has a thickness of 2˜6 mm and a porosity of 90% and 20˜40 ppi(pores per inch). When water as electrolyte solution is provided into the interior of the cell, the rubber tube connector 91 provided in the water container is connected with the rubber tube 21 of the rubber housing 20, so that electrolyte solution is provided through the tube. At this time, the paths into which water is provided are formed in a zigzag pattern for thereby achieving a consecutive supply of water. When supply of water is finished, the salt in the salt bag 92 provided in the interior of the water container 90 starts dissolving and is supplied to the cell (FIG. 7).

### EMBODIMENT 1

In the present invention, the metal frame 10 is rectangular metal frame formed of a window lattice shape such as a union jack shape or formed with punched holes. The four sides of the rectangular metal frames have bent portions 11 bent at 90°, and the four bent portions are draw-formed with a depth of 0.8˜1.2 mm. The four angular corners of the bent portions 10 are cut away at 45°, so that the four corners are not overlapped when folding the same.

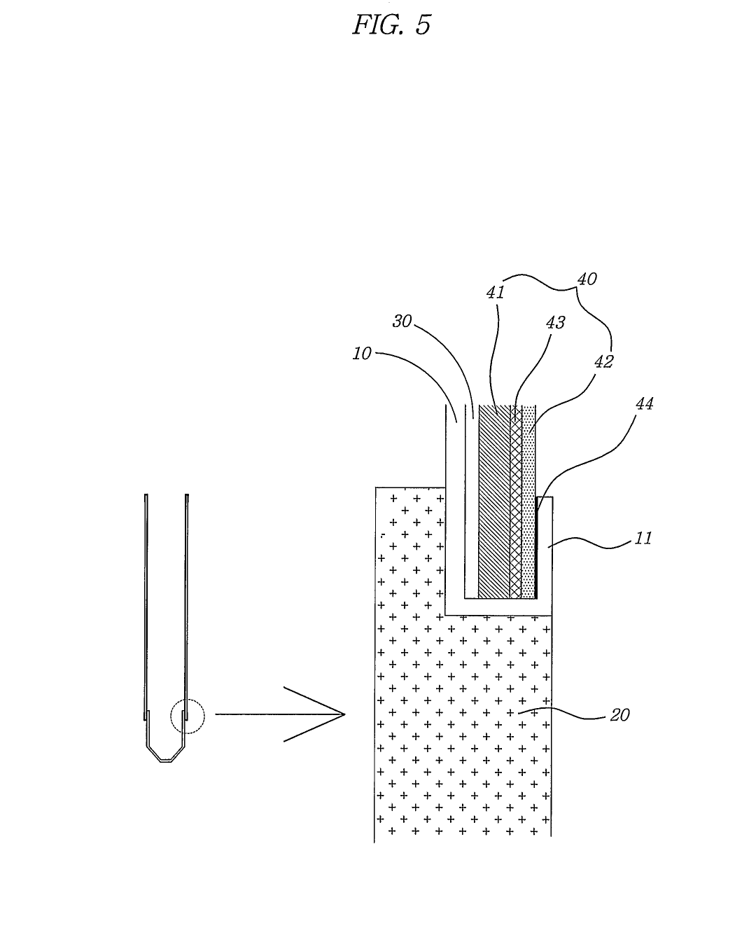

FIG. 5 is an enlarged cross sectional view of a part of a unit cell fabricated using the metal frame 10 having a union jack shaped window lattice as shown in FIG. 2A. As shown therein, the separator 30 is adhered to the metal frame 10. Thereafter, the air cathode 40 coated with the carbon layer 41 and the hydrophobic layer 42 is adhered to the upper part of the separator 30. Here, the nickel mesh 43 of the air cathode 40 is disposed between the carbon layer 41 and the hydrophobic layer 42 and collects and transfer current. A adhesive is applied to the edge of the hydrophobic layer 42 of the air cathode 40 before bent portions 11 of the metal frame 10 is compressed, so that a glue layer 44 is formed for thereby preventing any leakage of water. Thereafter, the bent portions 11 of the metal frame 10 are compressed.

### EMBODIMENT 2

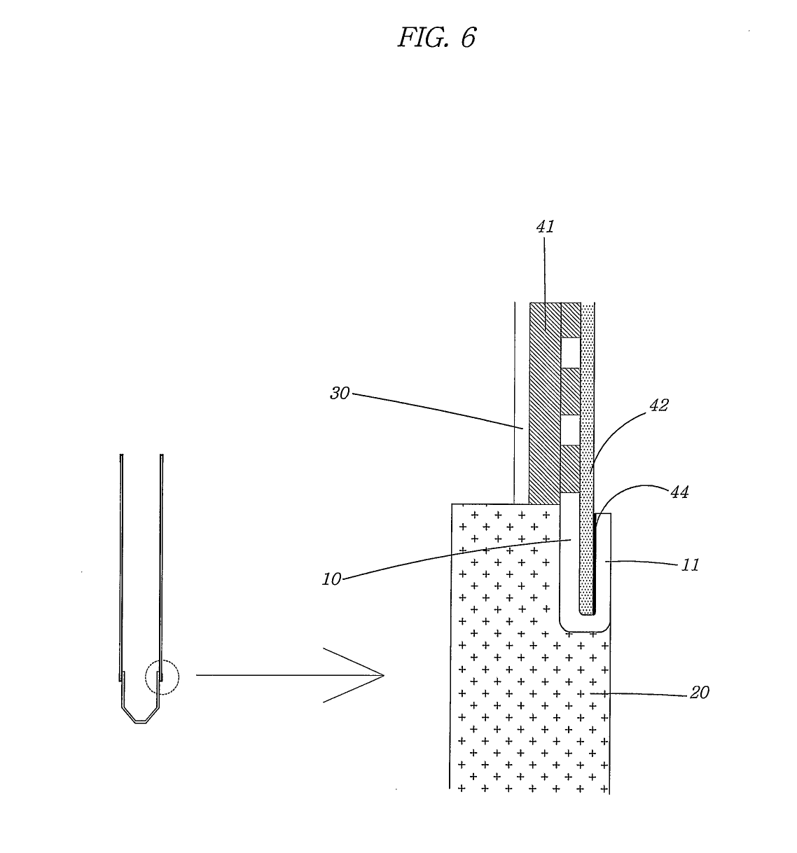

In the present invention, the metal frame 10 is a rectangular metal frame formed of a window lattice shape such as a union jack shape or formed with punched holes. The four sides of the rectangular metal frames have bent portions 11 bent at 90°. FIG. 6 is an enlarged cross sectional view of a part of the unit cell fabricated using a metal frame having small punched holes 13 as shown in FIG. 2B. Here, the inner side of the metal frame 10 having a plurality of small holes with a diameter of 1mm operates as the nickel mesh. The punched holes 13 are formed based on a press and punching method. An active carbon powder same as the carbon layer 41 is filled into the interior of the metal frame 13. The inner side of the same operates as a path of air or oxygen. The adhesive is applied to an edge of the hydrophobic layer 42 in the same manner as the first embodiment of the present invention. The above air cathode may decrease the fabrication cost and a thickness of the metal air fuel cell.

### EMBODIMENT 3

The metal frame 10 is fabricated through a press compression and a cutting process. The metal frame 10 is a stainless steel plate (316 code) and a nickel plate (purity of 99.8%). The surface of the metal frame 10 is scratched based on a sand blasting method before the rubber glue is applied to the edge of the metal frame 10. A pair of metal frames 10 is inserted into the rubber mold and is cured at 180° C. under a pressure of 50 kg/cm² for 60 seconds. Thereafter, the rubber housing is connected to a pair of the nickel frames. The air cathode 40 is O-Cat of the U.S. Evionyx Inc. As shown in FIGS. 5 and 6, it is coupled to the metal frame 10 together with the polypropylene separator 30. Any water leakage is not shown after a long time use of two weeks.

### EMBODIMENT 4

As shown in FIGS. 6 and 7, the metal frame of 200 mm×105 mm×0.2 mm is fabricated using a press. Holes each having a diameter of 1 mm is formed in the area of 180 mm×85 mm at an interval of 1.5 mm using a punch. The hydrophobic layer is the product of the W. L. Gore and Associates Tex called as an air diffusion film and is adhered to the nickel plate. The active carbon powder having a specific surface area of 1000m²/g is mixed with a PVDF (polyvinylidene fluoride) solution having solid PVDF powder of 20% by weight in 80% NMP (n-methyl-2-pyrrolidone). A mixture that an activated carbon powder, 60% based on a weight, is mixed with the PVDF solution of 40%, and is coated on the punched nickel plate of 180 mm×85 mm. The carbon coat on the punched area of the punched nickel frame is formed for one minutes at 200˜240° C. under a pressure of 10 kg/cm². An edge of the air anode is compressed by a press machine and is changed to a structure as shown in FIG. 6 and is rubber-molded in the rubber mold under the same condition as the third embodiment. The resulting unit cell is stable, and water leakage is not shown.

### EMBODIMENT 5

The unit cell was tested in solutions of 12% sodium chloride, of 12% sodium chloride and 1% sodium hydroxide. The air cathode assembly fabricated according to the third embodiment of the present invention was used. The aluminum anode used is an alloy containing magnesium of 2.5%. The magnesium electrode used is alloy of 4% aluminum and 0.5% zinc.

The thickness is 1 mm, and the height is 90 mm, and the width is 180 mm. In the case of a collapsed stack cell having 12 unit cells and 13 air diffusion plates, the length of the cell is 125 mm in a state that the metal anode is removed, and the length is maximum 310 mm in it is expanded.

In the case that the aluminum electrode is used, when the cells are connected in series, 30˜36 watts in salt water of 12% and 60˜90 watts in 12% of salt and 1% of sodium hydroxide resulted. In the case that the magnesium electrode is used, 80˜120 watts in the range of 14˜17 volts is obtained in 12% of salt water.

### EMBODIMENT 6

In the present invention, the electrolyte is fabricated as the salt bag 92 in the water container 90 is dissolved. Products are oxides, hydroxides of aluminum and magnesium and are easily removed from the rubber housing. The stack cell was tested and showed a good durability through a continuous test of about 250 hours and 10 recharging tests. Any degradation of the property was not observed.

### EMBODIMENT 7

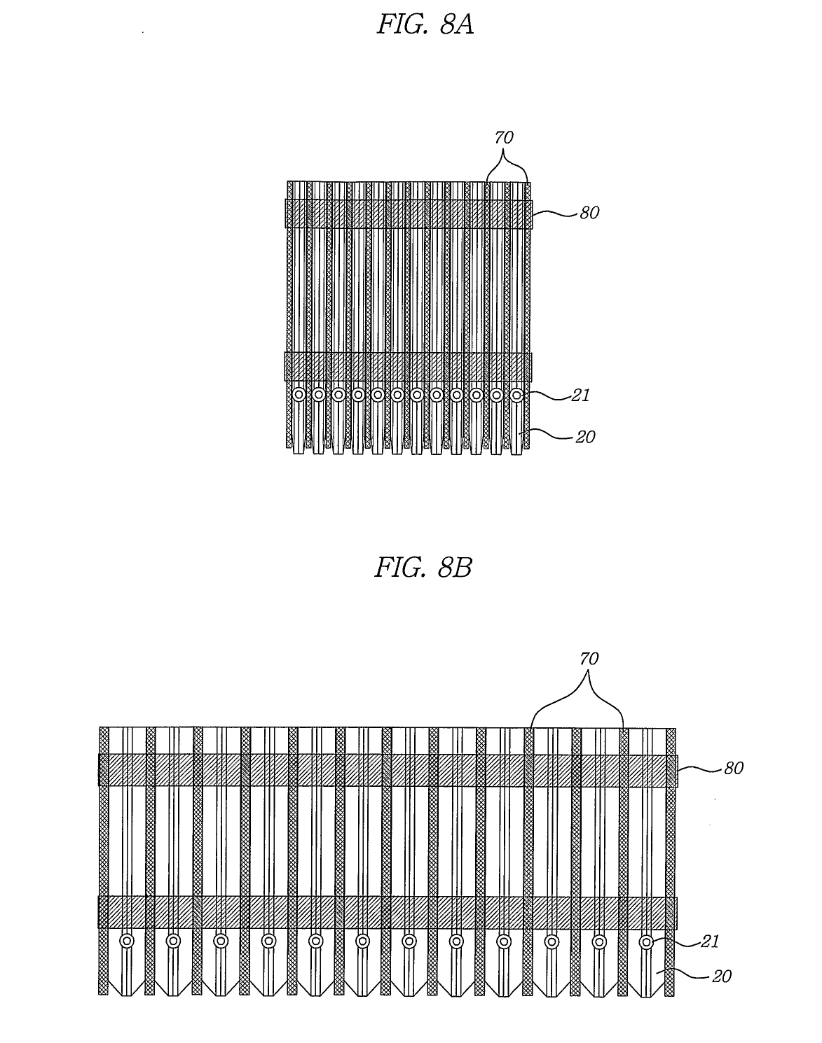

FIGS. 8A and 8B are views illustrating a characteristic that the metal air battery according to the present invention is collapsible. Since the solution filled in the interior of the cell is not harmful to human body, the user is able to remove water from the battery. Accordingly, it is possible to decrease the size and weight when storing or carrying the cell. Air diffusion plates 70 provided between the unit cells worked to prevent the air electrode 40 from being over protruded by the water filled. The air diffusion plate 70 has a porosity of 90% with 10˜40 ppi(pores per inch).

The length of the collapsed cells is 50% of the length when the cells are expanded as shown in FIG. 8A. The collapsible structure according to the present invention is one of the major features of the present invention. The rubber band 80 is adhered to the left and right sides of the cell and stably supports the cells.

### INDUSTRIAL APPLICABILITY

As described above, in the collapsible metal air battery according to the present invention, a plurality of unit cells are connected in series for thereby forming a collapsible stack cell. Therefore, the collapsible cell according to the present invention is very easy to store and carry. The cell according to the present invention has a small weight and volume. In the case that a user wants an emergency power, the user is needed to supply water for thereby generating a desired electric power. Since the cell according to the present invention is stored in a dried state, it is possible to store and use the cell according to the present invention for a long time period.

The present invention is not limited to the above embodiment. As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A collapsible metal air fuel cell, comprising: a unit cell including: a pair of metal frames; a rubber housing adhered to left, right and lower sides of the metal frames; a separator and an air cathode adhered to an outer side of the metal frame; and a plate like metal fuel electrode inserted into the interior of the metal frames.

2. The cell of claim 1, wherein said separator is polypropylene non-woven fabric.

3. The cell of claim 1, wherein said air cathode has one surface coated with a porous hydrophobic layer, and another surface coated with an activated carbon powder.

4. The cell of claim 1, wherein said metal air fuel electrode is a metal composed of aluminum and magnesium.

5. The cell of claim 1, wherein said metal frame has bent portions in the four sides of a rectangular metal frame, wherein the inner side of the same is formed in a window lattice shape.

6. The cell of claim 1, wherein said metal frame has bent portions in the four sides of a rectangular metal frame, wherein the inner side of the same is formed with punched holes.

7. The cell of claim 5, wherein said metal frame has angular corners of the bent portions cut away at 45° and are not overlapped when the bent portions of the metal frame are folded, and the bent portions are draw-formed by a depth of 0.8˜1.2 mm.

8. The cell of claim 1, wherein said rubber housing includes a pair of rubber tubes in the lower sides of the left and right sides.

9. A method for fabricating a collapsible metal air fuel cell, comprising the steps of:
the first step for curing at 150˜290° C. for 40˜210 seconds and forming a rubber housing in a metal frame;
the second step for adhering a separator to an outer side of the metal frame;
the third step for adhering an air cathode to an upper side of the separator; and
the fourth step for folding bent portions of the metal frame using a press machine.

10. The method of claim 9, wherein when compressing the bent portions of the metal frame of the fourth step using a press machine, a metal insertion material is inserted into the interior of the cell.

11. The cell of claim 1, wherein when a plurality of unit cells are connected in series, an air diffusion plate is inserted between the unit cells, and a rubber band is adhered to the left and right sides of the cell.

12. The cell of claim 11, further comprising a water container having a rubber tube connector.

13. The cell of claim 12, wherein said water container includes a salt bag formed of a porous non-woven fabric and having electrolyte salt.

14. The cell of claim 12, wherein said air diffusion plate has the porosity of 90% with 10˜40 ppi.

15. The cell of claim 12, wherein said rubber tube connector is connected with a rubber tube formed in a rubber housing in a zigzag pattern, so that electrolyte is consecutively filled.

16. The cell of claim 12, wherein said metal frame has angular corners of the bent portions cut away at 45° and are not overlapped when the bent portions of the metal frame are folded, and the bent portions are draw-formed by a depth of 0.8˜1.2 mm.
